(19) United States
(12) Patent Application Publication
(10) Pub. No.: US 2012/0168659 A1
(43) Pub. Date: Jul. 5, 2012

(54) BUTTERFLY VALVE

(76) Inventors: Yoshito Ozaki, Nobeoka-city (JP); Akihiro Shakagori, Nobeoka-shi (JP)

(21) Appl. No.: 13/394,750

(22) PCT Filed: Sep. 1, 2010
(86) PCT No.: PCT/JP2010/064968

§ 371 Date: Mar. 16, 2012

(30) Foreign Application Priority Data
Sep. 7, 2009 (JP) 2009-205406

(51) Int. Cl. F16K 1/226

(52) U.S. Cl. 251/306

(57) ABSTRACT

In a butterfly valve having: a seat ring that is mounted on the inner circumferential face of a valve body; a valve stem that passes through a through hole in the seat ring, and is supported by the valve body; and a discoid valve element that is supported by way of fixing the valve stem in a valve stem hole, and which is opened and closed as a result of the valve element turning together with the valve stem turning, a hollow cylindrical bush is inserted into the through hole in the seat ring, and is mounted in a sealed manner in a valve stem fitting hole provided in the valve element, without projecting beyond the outer circumferential face of the seat ring.

### BACKGROUND OF THE INVENTION

The present invention relates to a butterfly valve, which is suitable for use in piping lines for chemical factories, water and sewage piping lines, and piping lines for farming and fisheries and the like; more specifically, it relates to a butterfly valve, which prevents leakage within the valve element, in which fluid leaks through a gap between the valve stem and a valve stem hole in the valve element when flexure occurs in the valve element as a result of fluid pressure when the butterfly valve is closed, and which prevents valve stem leakage, in which fluid leaks into the stem seal between the valve stem and a through hole in the seat ring, and with which assembly of the seat ring and the valve element in valve body is improved.

As shown in FIG. 11 through FIG. 13, conventional butterfly valves made from resin have generally comprised: a hollow cylindrical valve body 101; an annular seat ring 102, mounted on the inner circumferential face of the valve body 101; a valve stem 103, which passes through the seat ring 102 and is supported by the valve body 101; and a valve element 105, which is supported by the valve stem 103, by way of the valve stem 103 passing through a valve stem hole 104, the valve element 105 being turned by way of turning the valve stem 103 so as to be brought into pressing contact with, or separated from, the seat ring 102, and thus open and close the fluid flow path.

In this case, if the sealing between the valve stem 103 and the seat ring 102 was insufficient, performing continuous opening and closing operations under high fluid pressure conditions resulted in fluid leaking through the stem seal 106 between the seat ring 102 and the valve stem 103, and flowing into the space between the seat ring 102 and the valve body 101, which is to say, to the back of the seat ring 107, where it remained, which resulted in a decreased diameter owing to expansion of the seat ring 102 in the radially inward direction, and thus there were problems in terms of increased operational torque and the risk of the valve element 105 ceasing to close.

Furthermore, with larger butterfly valve bores, there is an increase in the flexure of the valve element 105 (see FIG. 12) that results from the fluid pressure which is applied when the valve is closed, so that the outer circumferential edge 108 of the valve element 105 is pulled in the radially inward direction on the upstream side to which the fluid pressure is applied (the left side in FIG. 12), resulting in the outer circumferential edge 108 of the valve element 105 on the upstream side, which is normally in pressing contact with the seat ring 102, separating from the seat ring 102, whereby a gap 109 sometimes formed (see FIG. 13), so that there was a risk of fluid flowing through this gap 109, into a gap 110 between the valve stem hole 104 and the valve stem 103.

At this time, even if fluid has leaked into the gap 110 between the valve stem hole 104 and the valve stem 103, because the valve element 105 on the downstream side (the right side in FIG. 13), to which fluid pressure is not applied, and the seat ring 102 are in strong pressing contact so as to be sealed, fluid will not leak through the valve, but there is a risk of the valve stem 103 being corroded as a result of the fluid and, in particular in cases where the fluid is a corrosive fluid, this was a problem in so much as there was a risk of corrosion of the metal valve stem 103 by the corrosive fluid leading to inferior valve durability, or valve failure. Furthermore, when the fluid was a slurry, there were problems in so much as, in addition to corrosion, there was a risk of particles in the slurry causing poor operation or severe abrasion, and thus markedly inferior valve durability.

A butterfly valve that overcomes the leakage of fluid through the stem seal 106 and the gap 110, which was a problem in conventional butterfly valves, is disclosed in JP-2005-133810-A. As shown in FIG. 14, this is a butterfly valve wherein, a step 202 is provided at the stem seal 201 of the butterfly valve, midway in the lengthwise direction of the outer face, wherein a portion that extends from the step 202, as far as one end, is a large diameter part 203, and a portion that extends from the step 202, as far as the other end, is a small diameter part 204; an annular protrusion 205, which extends in the circumferential direction, and which protrudes toward the end on the small diameter part side, is provided on the step 202, extending in the circumferential direction; the annular protrusion 205 serves as a part that abuts against the outer circumferential face of the seat ring 206; a flange 208 is provided at the end of the large diameter part 203, serving to fix this in place in the valve body 207; and a bush 210 is used, wherein the outer circumferential face of the small diameter part 204 serves as a sliding face with respect to the valve element 209, and consequently, by fixing the flange 208 on the bush 210 in place in the valve body 207, the annular protrusion 205, abuts against the outer circumferential face of the seat ring 206, whereby leakage of the fluid that flows in the fluid flow path around the valve stem 212 can be easily and reliably prevented.

### SUMMARY OF THE INVENTION

However, the conventional butterfly valve using a bush on the valve stem 211 described above was assembled by: mounting the seat ring 206 in the valve body 207; installing the valve element 209 within the seat ring 206; then inserting the bush 210 into a vertical through hole 212 in the valve element 207, with the small diameter part 204 first; subsequently, inserting the valve stem 211; subsequently advancing the small diameter part 204 into the valve element 209, so that the annular protrusion 205 abuts against the outer circumferential face of the seat ring 206; and tightening the flange 208 on the large diameter part 203 on the valve body 207 using a bolt.

At this time, in order that the small diameter part 204 be inserted smoothly into the valve element 209, it was necessary that the centers of the through holes 212, 214 in the valve body 207 and the seat ring 206, and the fitting hole 215 in the valve element 209 coincide, but because the outer diameter of the seat ring 206 is generally formed slightly larger than the inner diameter of the valve body 207, and the outer diameter of the valve element 209 is formed slightly larger than the inner diameter of the seat ring 206, when the seat ring 206 is mounted in the valve body 207, and when the valve element 209 is placed in the seat ring 206, it was necessary to bend or squeeze the seat ring 206 and thus it was not easy to assemble these while maintaining the alignment of the centers of the through holes 212, 214 and the fitting hole 215, and thus there were problems in terms of assembly and fine adjustment. In particular, there was a problem in that, because the weights of the parts were great as a result of the parts being made of metal and the bores being large, the time and labor spent became excessive.

Furthermore, with the bush 210, the flange 208 and the valve body 207 were tightened using a bolt, and therefore the valve body 207 and a top flange 213 had to be provided separately, which increased the number of parts, which was a problem in that this increased the time required for assembly and for parts management. Furthermore, because it was not possible to insert the bush 210 from the interior of the valve body 207, it was also necessary to provide a through hole 212 at the bottom of the valve body 207 in order to insert the bush 210 into the valve body 207, and thus there was a problem in that there was a possibility of leaks occurring through the through hole 212 at the bottom of the valve body 207.

The present invention is a reflection of the problems in the prior art such as described above, and an object thereof is to provide a butterfly valve, which prevents leakage within the valve element, in which fluid leaks through a gap between the valve stem and a valve stem hole in the valve element when flexure occurs in the valve element as a result of fluid pressure when the butterfly valve is closed, and which prevents valve stem leakage, in which fluid leaks into the stem seal between the valve stem and a through hole in the seat ring, and with which assembly of the seat ring and the valve element in valve body is improved.

In a butterfly valve having: a seat ring that is mounted on the inner circumferential face of a valve body; a valve stem that passes through a through hole in the seat ring, and is supported by the valve body; and a discoid valve element that is supported by way of fixing the valve stem in a valve stem hole, and which is opened and closed as a result of the valve element turning together with the valve stem turning, a first characteristic is that a hollow cylindrical bush is inserted into the through hole in the seat ring, and is mounted in a sealed manner in a valve stem fitting hole provided in the valve element, without projecting beyond the outer circumferential face of the seat ring.

A second characteristic is that a flange is provided on the bush, on the side thereof that corresponds to the outer circumferential face of the seat ring.

A third characteristic is that an annular protrusion, which extends in the direction of the inner circumference of the seat ring, is provided at the outer edge of the flange.

A fourth characteristic is that the flange is provided at the top end of the bush, on the side thereof that corresponds to the outer circumferential face of the seat ring.

A fifth characteristic is that the top end face of the bush, on the side thereof that corresponds to the outer circumferential face of the seat ring, is curved.

A sixth characteristic is that the bush is installed so as to be non-turnable with respect to the seat ring.

A seventh characteristic is that an annular groove for mounting a sealing member is provided on at least one of: a valve element fitting part that is formed on the outside of the bush; and the valve stem fitting hole in the valve element.

An eighth characteristic is that a stepped portion for mounting the sealing member is provided on at least one of: the valve element fitting part; and the valve stem fitting hole.

A ninth characteristic is that the valve element is turned by any one drive system from among manual drive systems, pneumatic drive systems and electric drive systems.

In the present invention, referring to FIG. 1, a bush 5, which is inserted into a through hole 11 in a seat ring 2 is installed so as to project only at the inner circumferential face of the seat ring 2, without projecting beyond the outer circumferential face of the seat ring 2; the length of the portion that projects beyond the seat ring 2, which is to say, the length of a valve element fitting part 22, is preferably such that the relationship between the length D of the valve element 4 in the direction of the valve stem 3 and the length L of the valve element fitting part 22 is such that 0.1 D≦L≦0.3 D. In order to provide a sufficient seal structure between the bush 5 and the valve element 4, and in order to solidly fit these so that the bush 5 and the valve element 4 do not come off during assembly, it is preferable that 0.1 D≦L, and so as to facilitate fitting and removal of the valve element 4 with respect to the seat ring 2, it is preferable that L≦0.3 D.

So long as a flange 18 is located on the bush 5, on the side thereof that corresponds to the outer circumferential face of the seat ring 2, this may be provided either at the top end or towards the top, and valve stem leakage can be prevented because a sealing area is formed in which the abutting surface between the flange 18 and the seat ring 2 is sufficiently extensive, and because it is possible to prevent deformation of the through hole 11 in the seat ring 2, by improving the strength in the vicinity of the through hole 11. At this time, in order to improve the seal performance achieved by the abutting surface, a plurality of substantially concentric annular protrusions, which are lower than the annular protrusion 19, may be provided on the inside or the outside of the annular protrusion 19.

The annular protrusion 19 may be formed anywhere, so long as this is on the flange 18, on the side thereof that corresponds to the outer circumferential face of the seat ring 2; and while there are no particular restrictions on this, if the annular protrusion 19 is provided at the outer edge of the flange 18, it is possible to effectively improve the strength in the vicinity of the through hole 11 in the seat ring 2, whereby deformation of the through hole 11 and movement of the seat ring 2 can be prevented, allowing sealing to be maintained, which maximizes the effects thereof; and therefore it is desirable to provide the annular protrusion 19 on the outer edge of the flange 18. Furthermore, in order to further increase the effect of the annular protrusion 19, concentric annular protrusions 19 may be provided at multiple locations.

The end face of the bush 5, on the side thereof that corresponds to the outer circumferential face of the seat ring 2, may be flat or curved, and while there are no particular restrictions on this, with a view to using the inner circumferential face of the valve body 1 to uniformly push the bush 5 onto the seat ring 2, when the butterfly valve is assembled, it is preferable that this have the same curvature as the curvature of the outer circumferential face of the seat ring 2. Furthermore, in such a case, because the orientations of curved faces at the end face of the bush 5 and the flange 18 on the side thereof that corresponds to the outer circumferential face of the seat ring 2, and the curved face at the outer circumferential face of the seat ring 2 must match, it is desirable that a protrusion be integrally provided on a side face of the bush 5 or the flange 18, or that the sectional shape of the bush 5 or the flange 18 be rectangular or elliptical, or a circular shape provided with a bevel or a protrusion, so that the bush 5 is not installed in the seat ring 2 in the wrong direction. Note that the end faces of the bush 5 and the flange 18, on the side thereof that corresponds to the inner circumferential face of the seat ring 2, may also be curved or flat, and there are no particular restrictions on this.

There are no particular restrictions as to whether the bush 5 is turnable or non-turnable with respect to the seat ring 2, but if one wishes to prevent abrasion at the abutting surface between the bush 5 and the seat ring 2, it is preferable that the bush 5 be provided so as to be non-turnable with respect to the seat ring 2. At this time, if the end face of the bush 5, on the side thereof that corresponds to the outer circumferential face of the seat ring 2, is a curved face having the same dimensions as the inner circumferential face of the valve body 1, even if the valve element 4 is turned, the bush 5 cannot turn with respect to the seat ring 2, but by providing an integral protrusion on a side face of the bush 5 or the flange 18, or causing the sectional shape of the bush 5 or the flange 18 be rectangular or elliptical, or a circular shape provided with a bevel or a protrusion, the situation will be more reliably such that the bush 5 cannot turn with respect to the seat ring 2.

The seal structure between the bush 5 and the valve element 4 is preferably a structure employing a sealing member 23 such as an O-ring, and specifically, a structure wherein an annular groove 24 is provided in the valve element fitting part 22 of the bush 5, for mounting the sealing member 23 (see FIG. 2), or a structure wherein an annular groove 24 is provided in the valve stem fitting hole 16 in the valve element 4, for fitting the sealing member 23, may be mentioned.

In terms of the material for the valve body 1 and the valve element 4 in the present invention, polyvinyl chloride (hereafter, referred to as PVC) and polypropylene (hereafter, PP) can be used, but synthetic resins such as polyvinylidene fluoride (hereafter referred to as PVDF), polyethylene (hereafter, referred to as PE), polyphenylene sulfide, polydicyclopentadiene (hereafter, referred to as PDCPD) and FRP, or metals such as stainless steel, copper, cast iron and cast steel may also be used, so long as these have the required strength and the required characteristics for the butterfly valve. From among these, it is preferable that the valve body 1 and the valve element 4 be made from synthetic resins. Because the present invention is particularly suitable for use with large bores, if this is made out of resin, as contrasted with cases in which this is made from metal, it will be markedly lighter, and the operational efficiency will be improved, and moreover it will be possible to use this without problems even in corrosive fluid applications.

The material for the valve stem 3 in the present invention may be cast iron, cast steel, carbon steel, stainless steel, titanium or the like, without particular restriction, so long as this does not present problems in terms of strength. Furthermore, the material for the seat ring 2 in the present invention is preferably an elastic material, which may be a rubber such as ethylene propylene rubber (hereafter, referred to as EPDM), nitrile rubber, fluororubber, or a synthetic resin such as PVDF or the like, without particular restriction, so long as this does not present problems in terms of strength or corrosion resistance.

There are no particular restrictions on the material for the bush 5 in the present invention, and this may be a resin or may be a metal, so long as this is corrosion resistant, and has sufficient strength such as not to be damaged even if flexure occurs, but this is preferably made from PVC, PP, PVDF, polytetrafluoroethylene (hereafter, referred to as PTFE), perfluoroalkoxy alkanes (hereafter, referred to as PFA), PE or the like. Metals are often used for the valve stem 3, and thus it is suitable that the material for the bush 5 be PVC, PP or PVDF, as corrosion of the valve stem 3 can be prevented, even if corrosive fluids are conducted, with an effect similar to that in the case where the valve stem 3 is coated with an anti-corrosive coating being achievable by way of the bush 5.

In the present invention, so long as the sealing member 23 brings about a reliable seal, there are no particular restrictions on the shape thereof, and this may be an O-ring or may be packing. In cases where the bush 5 can be moved, the sealing member 23 slides while maintaining a seal between the sealing member 23 and the sealing surface, and thus an O-ring, which is well suited to sliding because of its circular sections shape, is suitable. Furthermore, there are no particular restrictions on the material for the sealing member 23, so long as this is commonly used as a sealing material, but in terms of mechanical characteristics, it is preferable that this have a low compression set, and EPDM and fluorine rubber may be mentioned in this regard. Furthermore, sealing members 23 may be installed at a plurality of locations in order to improve the sealing performance brought about by the sealing member 23, and sealing members 23 having differing diameters or thicknesses may be used in order to improve the long-term durability thereof.

The present invention has a structure such as described above and achieves the following excellent effects.

(1) Because the bush is mounted in the valve element in a sealed manner, without protruding beyond the outer circumferential face of the seat ring, it is possible to combine the seat ring, the valve element and the bush with the valve body, via the opening provided in the front face of the valve body, with the seat ring, the valve element and the bush in the assembled state. In other words, assembly is facilitated because the seat ring, in which the bush and the valve element are mounted, can easily be combined with the valve body in the horizontal direction thereof.

(2) Because the top end face of the bush, on the side thereof that corresponds to the outer circumferential face of the seat ring, abuts against the inner circumferential face of the valve body, it is no longer necessary to provide additional parts that hold down the bush, and thus the number of parts can be reduced.

(3) By providing a flange and an annular protrusion on the bush, a sealing area is provided wherein there is sufficient expanse between the bush and the seat ring, and the strength in the vicinity of the through hole in the seat ring is reinforced, so that it is possible to prevent valve stem leakage and movement of the seat ring, even if this is used for a long period of time.

(4) Because a sealing area is provided between the valve element fitting part of the bush and the fitting hole in the valve element, it is possible to prevent leakage within the valve element, even if this is used for a long period of time.

### BRIEF DESCRIPTION OF THE DRAWINGS

FIG. 1 is a longitudinal sectional view showing a butterfly valve in a first mode of embodiment of the present invention, when completely closed.

FIG. 2 is an enlarged longitudinal sectional view of a key area in FIG. 1.

FIG. 3 is a front view showing the situation in which the bushes have been inserted into the seat ring, when assembling the butterfly valve of the first mode of embodiment.

FIG. 4 is a front view showing the situation in which the valve element has been placed in the seat ring of FIG. 3.

FIG. 5 is a front view showing the situation in which the bushes and the valve element have been combined with the seat ring of FIG. 4.

FIG. 6 is a front view showing a butterfly valve in the first mode of embodiment of the present invention, when fully open.

FIG. 7 is a longitudinal sectional view showing the situation in which flexure of the valve element has occurred due to the application of fluid pressure on the upstream side, when the butterfly valve of the first mode of embodiment is fully closed.

FIG. 8 is an enlarged longitudinal sectional view of a key area in FIG. 7.

FIG. 9 is an enlarged longitudinal sectional view of a key area in a second mode of embodiment of the present invention.

FIG. 10 is a partial sectional view showing a butterfly valve with a pneumatic drive system in a third mode of embodiment.

FIG. 11 is a longitudinal sectional view showing a conventional butterfly valve when fully closed.

FIG. 12 is a longitudinal sectional view showing the situation in which flexure of the valve element has occurred due to the application of fluid pressure on the upstream side, when the conventional butterfly valve is fully closed.

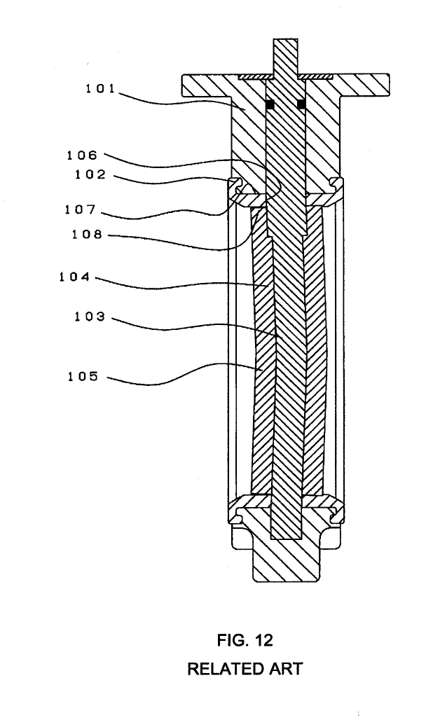

FIG. 13 is an enlarged longitudinal sectional view of a key area in FIG. 11.

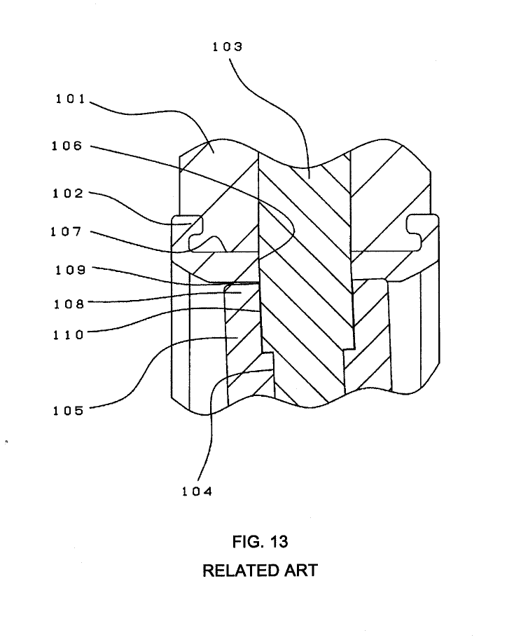

FIG. 14 is a longitudinal sectional view showing another conventional butterfly valve when fully closed.

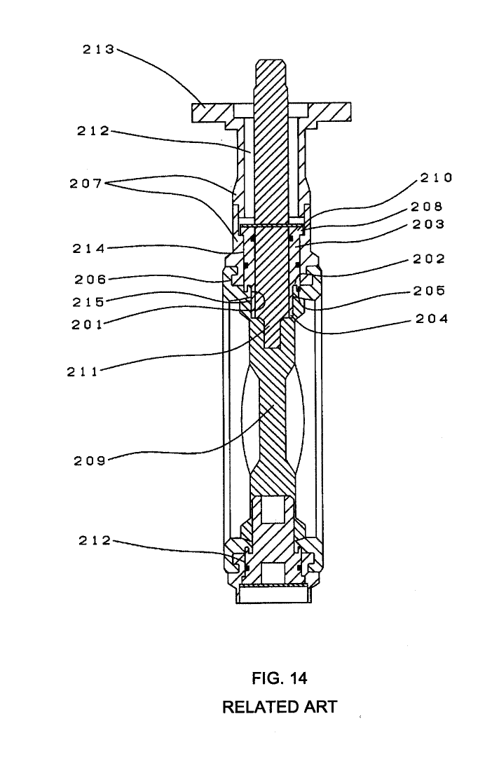

### DETAILED DESCRIPTION OF THE INVENTION

Hereafter, the first mode of embodiment of the present invention is described with reference to the drawings, but needless to say, the present invention is not limited to this mode of embodiment.

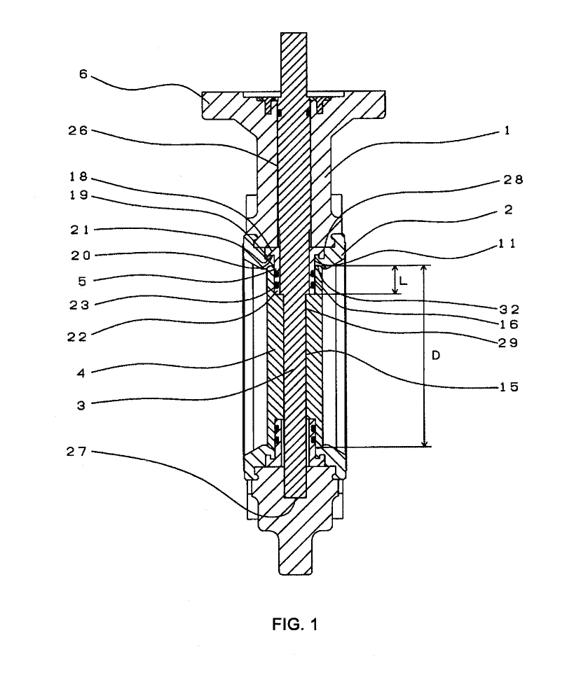

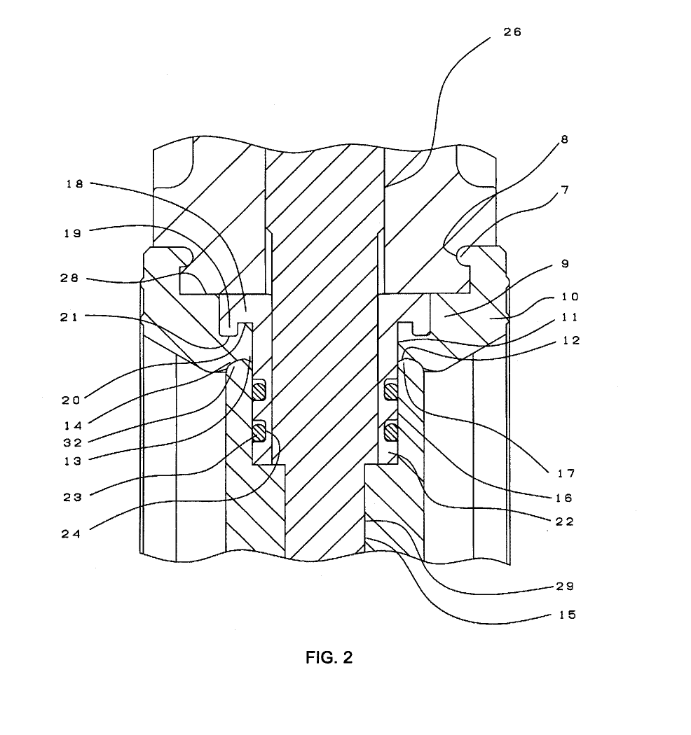

In FIG. 1 and FIG. 2, a hollow cylindrical valve body 1, which is made from polypropylene and has a nominal diameter of 100 mm, is provided at the top with a substantially disk shaped top flange 6, which projects at the outer periphery; a seat ring 2, which is described hereafter, is mounted in the inner circumferential face of the valve body 1, and a fitting groove 8 is provided in the vicinity of the opening, on both sides of the valve body 1, into which fit wings 7 on the seat ring 2. In the present invention, a wafer type valve body 1 is used, but valve bodies such as those of the lug type, and of those of the double flange type can also be used.

The seat ring 2, which is made from EPDM, is such that flange faces 10 are integrally formed on both sides a hollow cylindrical main body 9. The outer circumferences of the flange faces 10 are formed so as to be circular and the wings 7, which are provided so as to project inwardly at the top end of the flange faces 10, fit into the fitting grooves 8 that are provided on both sides of the valve body 1, so that the seat ring 2 does not move.

Furthermore, the main body 9 has a through hole 11 through which a valve stem 3, which is described hereafter, passes vertically, in the axial direction of the valve stem 3; and a fitting recess 20 and a fitting groove 21 are formed around the through hole 11, into which respectively fit a flange 18 and an annular protrusion 19 on the bush 5, which are described hereafter. The inner circumference of the seat ring 2 is formed so as to be circular, and a circular annular protrusion 13, the outer circumference of which having a face 12 that is tapered in the axial direction of the valve stem, is provided so as to project in the radially inward direction at the circumferential edge of the through hole 11. A spherical recess 14, which is normally in pressing contact with a valve element 4, which is described hereafter, is provided at the outer circumference of the circular annular protrusion 13 of the seat ring 2. The contact face of the boss part 14 is provided in the form of a recessed spherical surface, matching the shape of the valve element 4, so as to improve the valve seat sealing characteristics.

The valve stem 3, which is made from SUS 403, comprises a central portion and a narrow diameter portion, having an outer diameter that is less than the outer diameter of the central portion, which is provided at the top of the valve stem 3; the top end of the narrow diameter portion is supported by the valve body 1, arranged so as to project beyond the center of the top flange 6, which is provided at the top of the valve body 1. Furthermore, the central portion of the valve stems 3 passes through the valve body 1 and the seat ring 2, in close contact therewith, so that the valve stem 3 can turn.

The circular valve element 4, which is made of polypropylene, is provided with a valve stem hole 15, which passes through the center of the valve element 4; in the opening of the valve stem hole 15 is formed a valve stem fitting hole 16, into which mounts a bush 5, which is described hereafter; and at the inner circumference of the end of the opening of the valve stem fitting hole 16, a mortar shaped circular annular recess 17 is provided. Furthermore, the valve stem 3 passes through the valve stem hole 15 in a non-turnable manner, so as to be supported by the valve stem 3, disposed at the interior center of the valve body 1. The circular annular recess 17 in the valve element 4 and the circular annular protrusion 13 on the seat ring 2, are put together so that the circular annular protrusion 13 fits in the circular annular recess 17.

The hollow cylindrical bush 5, which is made of polypropylene, has a flange 18 formed at the top, on the side thereof that corresponds to the outer circumferential face of the seat ring 2; and at the outer edges of the flange 18, an annular protrusion 19 is formed, which extends in the direction of the inner circumference. The flange 18 and the annular protrusion 19 are inserted into the seat ring 2, mounted in the fitting recess 20 and the fitting groove 21, which are formed around the through hole 11 in the seat ring 2, which prevents deformation of the through hole 11, and forms sealing surfaces between the flange 18 and the annular protrusion 19 and the outer circumferential face of the seat ring 2. Furthermore, a curvature identical to that of the outer circumferential face of the seat ring 2 is formed, wherein the top end face, on the side thereof that corresponds to the outer circumferential face of the seat ring 2, and the top end face of the flange 18 are formed continuous, and this abuts against the inner circumferential face of the valve body 1, in the same manner as the outer circumferential face of the seat ring 2, thereby eliminating the need to provide an additional part in order to hold down the bush 5, which allows the number of parts to be reduced.

Furthermore, the forward end of the bush 2, on the side thereof that corresponds to the inner circumferential face of the seat ring 2, protrudes beyond the seat ring 2 as a valve element fitting part 22, which fits into the valve shaft fitting hole 16 in the valve element 4. The length of the valve element fitting part 22 is 17 mm, and annular grooves 24 are formed in two places on the outer circumferential face of the valve element fitting part 22, in which sealing members 23 are mounted, so that sealing is maintained between the valve element fitting part 22 and the valve shaft fitting hole 16, as a result of the pressing force against the inner circumferential face of the valve shaft fitting hole 16 in the valve element 4.

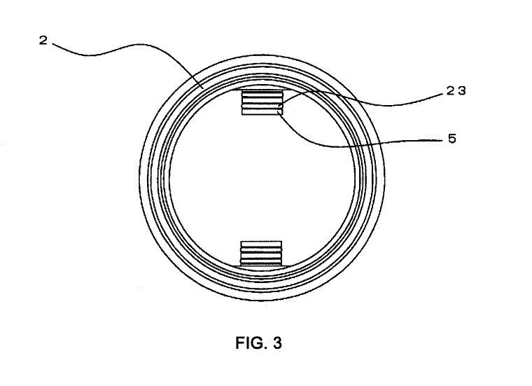

Next, a method of assembling the butterfly valve is described. First, the bush 5 is inserted into the vertical through hole 11 in the seat ring 2, matching the curvature of the outer circumferential face of the seat ring 2 with the curvature of the top end face of the bush 5, on the side thereof that corresponds to the outer circumferential face of the seat ring 2, so that the flange 18 and the annular protruding part 19 on the bush 5 fit into the fitting recess 20 and the fitting groove 21 in the seat ring 2, and so that this fits without the end face of the bush 5, on the side thereof that corresponds to the outer circumferential face of the seat ring 2, protruding beyond the outer circumferential face of the seat ring 2 (see FIG. 3). At this time, because the annular protruding part 19 fits deeply into the fitting groove 21, the bush 5 will not come out of the seat ring 2 during assembly, and therefore assembly is extremely easy.

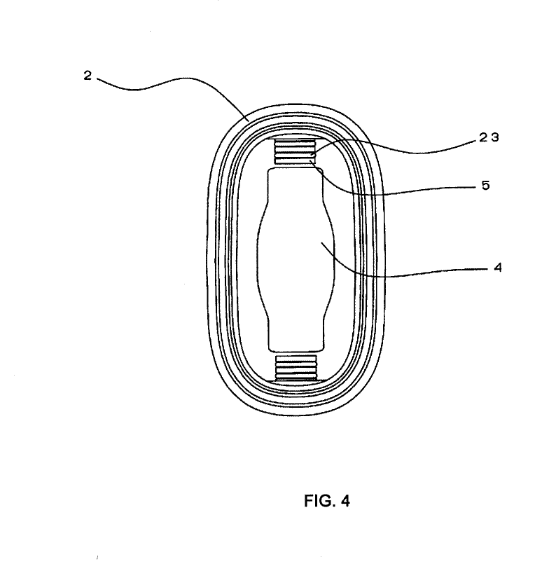

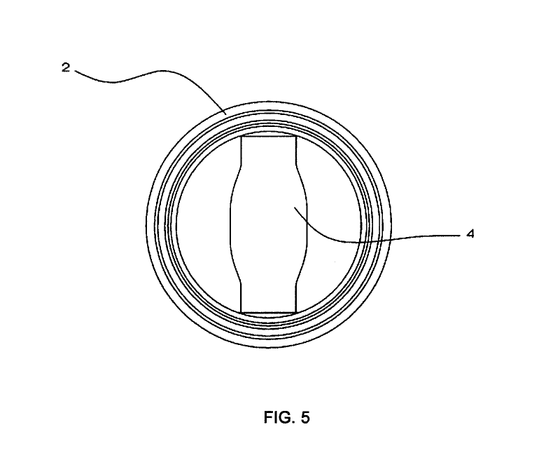

Next, force is applied from both sides of the seat ring 2, toward the inner circumference, in a direction perpendicular to the axial direction of the through hole 11, so as to squeeze the seat ring 2 out in the axial direction of the through hole 11, until the distance between the ends of the bushes 5, on sides thereof that correspond to the inner circumferential face of the seat ring 2, which have been mounted in the top and bottom of the seat ring 2, is greater than the length of the valve element 4 in the direction of the valve stem 3. After squeezing the seat ring 2, the valve element 4 is placed between the top and bottom bushes 5, in the fully open or half open state (see FIG. 4); the valve element fitting part 22 on one of the bushes 5 is inserted into one of the valve stem fitting holes 16 in the valve element 4, and while relaxing the force applied to the seat ring 2, the valve element fitting part 22 on the other bush 5 is inserted into the other valve stem fitting hole 16; then after releasing the force applied to the seat ring 2, the bushes 5 are pushed in the direction of the valve stem 3, so as to fit the valve element fitting parts 22 of the bushes 5 into the valve stem fitting holes 16 in the valve element 4 (see FIG. 5). At this time, the valve element fitting part 22 of the bush 5 protrudes beyond the inner circumferential face of the seat ring 2, and therefore assembly is extremely easy because it is possible to align the valve stem fitting hole 16 in the valve element 4 and the through hole 11 in the seat ring 2, without finely adjusting the centers thereof.

Next, the seat ring 2, on which the bush 5 and the valve element 4 have been mounted, is mounted in the valve body 1, from the horizontal direction, via the opening provided in the front of the valve body 1, so that the center of the through hole 11 in the seat ring 2 and the center of the valve stem through hole 26 in the valve body 1 coincide. At this time, because the annular protruding part 19 on the bush 5 is fitted deeply in the fitting groove 21 in the seat ring 2, and the valve element fitting part 22 of the bush 5 is fitted deeply in the valve shaft fitting hole 16 in the valve element 4, assembly is extremely easy, because while the seat ring 2 is being mounted in the valve body 1, the centers of the seat ring 2, the bush 5 and the valve element 4 will not be misaligned, nor will the parts fall out. Furthermore, because the bush 5 and the valve element 4 have already been mounted in the seat ring 2, it is possible to combine the three types of parts with the valve body 1 with good precision, so that the assembly is extremely efficient.

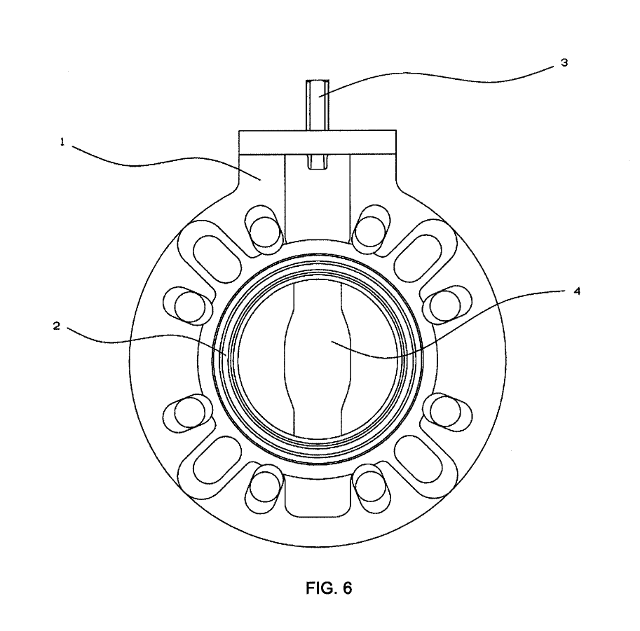

Next, the valve stem 3 is inserted via the valve stem through hole 26 in the top flange 6 on the valve body 1, so as to reach the bottom of a valve stem receptacle 27 at the bottom of the valve body 1 (see FIG. 6), and a handle which is a drive part (not shown in the drawing) is installed at the top of the valve stem 3, which protrudes at the top of the top flange 6.

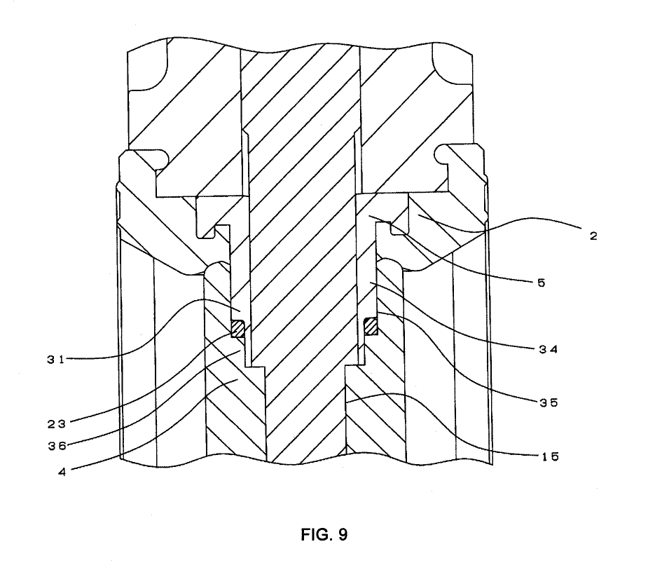

Next, a second mode of embodiment of the present invention is described based on FIG. 9. In this mode of embodiment, constituent elements that are the same as in the first mode of embodiment described above are given the same reference numerals.

A valve stem fitting hole 35, in which a bush 5 is mounted, is formed in the opening of a valve stem hole 15, in a circular valve element 4, which is made of polypropylene, and a stepped portion 36 is formed on the inner circumferential face of the valve stem fitting hole 35, serving to mount a sealing member 23. The hollow cylindrical bush 5, which is made of polypropylene, is such that a valve element fitting part 34, which fits in the valve stem fitting hole 35 of the valve element 4, is formed on the side thereof that corresponds to the inner circumferential face of the seat ring 2, and a stepped portion 31 is formed on the outer circumferential face of the forward end of the valve element fitting part 34, serving to mount the sealing member 23.

In this mode of embodiment, the sealing member 23 is held trapped between the stepped portion 31 formed on the valve element fitting part 34 and the stepped portion 36 formed in the valve stem fitting hole 35, whereby sealing is maintained between the valve element fitting part 34 and the valve stem fitting hole 35. Furthermore, it suffices that a stepped portion 31, 36 be provided on either one of the valve stem fitting hole 35 or the valve element fitting part 34, and the sealing member 23 may be held trapped between the stepped portion 31 on the valve element fitting part 34 and the bottom of the valve stem fitting hole 36, without a stepped portion 36 being provided in the valve shaft fitting hole 35. Furthermore, the sealing member 23 may be held trapped between the stepped portion 36 in the valve stem fitting hole 35 and the end face of the valve element fitting part 34, without a stepped portion 31 being provided on the valve element fitting part 34. The configuration of the rest of the valve element 4 and the bush 5 in this mode of embodiment, as well as the configurations of the other parts, and the operation thereof, is the same as in the first mode of embodiment described above, and a description thereof is therefore omitted.

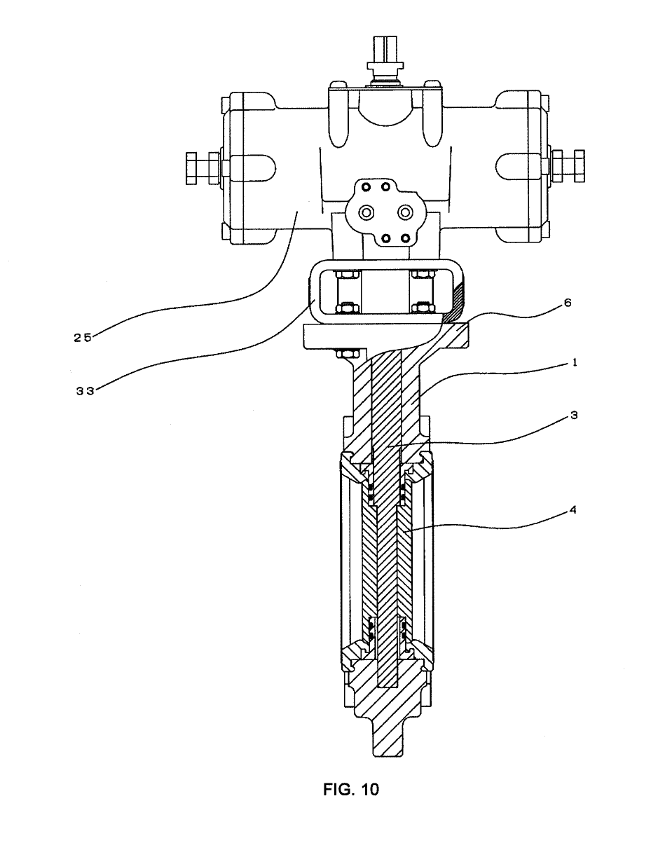

Next, a third mode of embodiment of the present invention is described based on FIG. 10. In this mode of embodiment, constituent elements that are the same as in the first mode of embodiment described above are given the same reference numerals.

A pneumatic drive unit 25 is mounted via a mount 33 on the top flange 6 of the valve body 1. The drive of the pneumatic drive unit 25 is transmitted to the top of the valve stems 3, so that the valve is opened and closed by way of turning the valve element 4, as a result of turning the valve stem 3. Note that, in place of a pneumatic drive unit 25, which is based on air pressure, an electric drive unit that includes a motor or the like may be provided, without particular limitation. Furthermore, if an electric drive unit is used, the electric drive unit is likewise mounted on the butterfly valve by way of the mount 33. The rest of the configuration of the valve body 1, the valve stem 3 and the valve element 4 in this mode of embodiment, as well as the configurations of the other parts, are the same as in the first mode of embodiment described above, and a description thereof is therefore omitted.

In this mode of embodiment, driving of the butterfly valve is performed by way of the pneumatic drive unit 25, which allows for remote operation and electrical control of the valve, enabling open/close operational control of valves installed in narrow spaces into which a person's hand could not enter, open/close operations such as high-frequency repeated opening and closing, and computer controlled opening and closing operations.

Next, the operation when the butterfly valve in this mode of embodiment is closed will be described.

If, starting from the state in which the valve is fully open, the valve stem 3 is turned, the valve element 4 turns in conjunction with this, so that the outer circumferential edge 32 of the valve element 4 makes pressing contact against the inner circumference of the seat ring 2, and a fully closed state is produced (see FIG. 1), so that a valve seating, which results from the inner circumference of the seat ring 2 and the outer circumferential edge 32 of the valve element 4, is sealed. Furthermore, the flange 18 and the annular protruding part 19 on the bush 5 abut in the fitting recess 20 and the fitting groove 21 of the seat ring 2, so that the end face of the bush 5, on the side thereof that corresponds to the outer circumferential face of the seat ring 2, is pressed in the inner circumferential direction of the seat ring 2 by the valve body 1, so that fluid does not leak between the seat ring 2 and the valve body 1, which is to say, to the back 28 of the seat ring, via the sealing area between the seat ring 2 and the bush 5. Furthermore, because the bush 5 and the valve element 4 are sealed by the sealing member 23 in the valve stem fitting hole 16 in the valve stem hole 15 of the valve element 4, fluid will not leak into the space 29 between the valve stem hole 15 and the valve element 4.

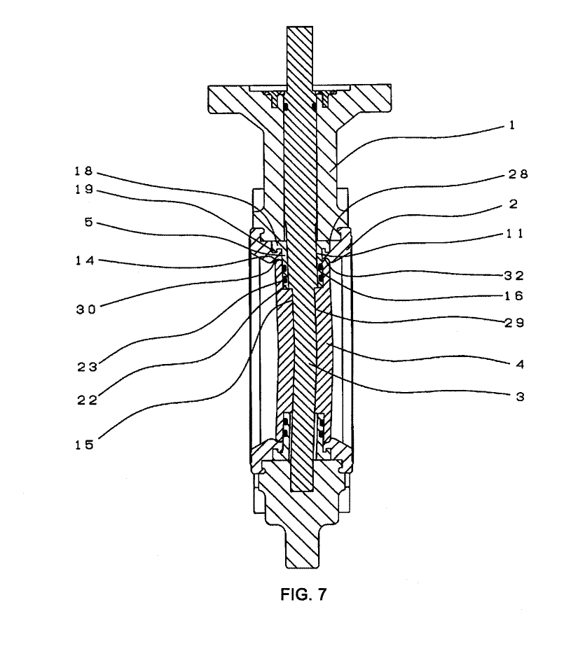

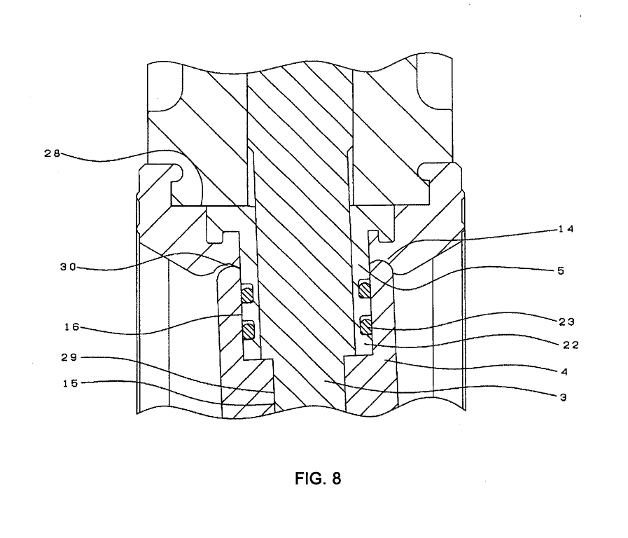

Next, when, starting from the situation in FIG. 1, fluid pressure is applied to the upstream side (the left side in FIG. 1), a flexure occurs in the valve element 4 due to the fluid pressure (the situation in FIG. 7, which is shown slightly exaggerated, in order to facilitate understanding). The greater the bore of the valve, the greater this flexure will be. Because the bush 5 is inserted into the seat ring 2, a sealing area is formed with a sufficient expanse between the seat ring 2 and the bush 5, due to the flange 18 and the annular protrusion 19, and the strength of the seat ring 2 in the vicinity of the through hole 11 is increased, which prevents deformation of the through hole 11 in the seat ring 2 and movement of the seat ring 2, whereby even if flexure occurs, this will not impact the seal between the through hole 11 and the bush 5, but as a result of the flexure, the outer circumferential edge 32 of the valve element 4 on the upstream side is pulled in the radially inward direction, whereby the outer circumferential edge 32 of the valve element 4 on the upstream side which is usually in pressing contact with the seat ring 2, is separated from the seat ring 2, and a gap 30 is produced. (See FIG. 8.) At this time, because the bush 5 is closely fitted on the valve stem 3, even if fluid that penetrates via the gap 30 makes liquid contact with the bush 5, it will not make liquid contact with the valve stem 3, and because the bush 5 is made of polypropylene which has good corrosion resistance, corrosion of the valve stem 3 can be reliably prevented, even if a corrosive fluid is conducted. Furthermore, because the valve element fitting part 22 of the bush 5 is fitted in the valve stem fitting hole 16 in the valve element 4, and a seal is formed by the sealing member 23, between the bush 5 and the valve element 4, it is possible for the bush 5 to move within the valve stem fitting hole 16 in response to the flexure of the valve element 4, whereby it is possible to prevent the stress resulting from the flexure from being applied to the bush 5. Here, the sealing surface, where the sealing member 23 seals with the valve element 4, may sometimes shift as a result of the movement of the bush 5, but because the sealing member 23 slides on the inner surface of the valve stem fitting hole 16 in the valve element 4, and simply moves to a suitable sealing position, the sealing does not change, whereby, even if flexure occurs in the valve element 4, the sealing can be maintained in the same manner as in situations in which there is no flexure.

Thus, even if flexure occurs in the valve element 4 as a result of fluid pressure, leakage of the fluid to the back 28 of the seat ring via the sealing area between the seat ring 2 and the bush 5 is prevented, and leakage of fluid into the gap 29 between the valve stem hole 15 in the valve element 4 and the valve stem 3 is prevented, whereby it is possible to reliably prevent corrosion and marked abrasion of the valve stem 3 by the fluid. In this regard, the effect is more pronounced in butterfly valves with large bores, in which the flexure will be great; the effect is also more pronounced in the case of marked abrasion of the boss part 14 on the seat ring 2, such as in the case of long-term use and cases where the fluid is a slurry.

Next, the valve seat sealing and the durability when continuously opened and closed were evaluated for the butterfly valve of the present invention, by way of the test methods set forth below.

### (1) Valve Seat Sealing Test

Based on the valve seat sealing test method in JIS B 2032, after applying water pressure for 1 minute at 1.5 MPa, which is 1.5 times the maximum allowable pressure, on the upstream side, with the valve closed, leakage to the downstream side, leakage within the valve element, and valve stem leakage were checked for visually. More specifically, for leakage on the downstream side, leaks were checked for at the sealing portion between the valve element 4 and the seat ring 2; for leakage within the valve element, a hole was opened in the center of the valve element 4, from the downstream side, and whether or not fluid leaked from the hole was checked; and for valve stem leakage, the leakage was checked for by way of the swelling on the radially inward side of the seat ring 2 resulting from water having penetrated to the back 28 of the seat ring.

### (2) Durability Test

Referring to the durability test method in JIS B 2032, using ambient temperature water, and without applying water pressure, full opening and full closing operations of the valve were repeated; and each time that 10,000 full opening and full closing operations were reached, a sealing test was performed, with the test being performed until a total of 100,000 full opening and full closing operations had been reached.

### Working Example 1

Valve seat sealing tests and durability tests were performed using the butterfly valve in the third mode of embodiment of the present invention, having a bore of 100 mm, which is to say, a butterfly valve wherein the bush 5, the top end face of which is curved, is provided with the flange 18 at the top, on the side thereof that corresponds to the outer circumferential face of the seat ring 2, and an annular protrusion 19 is provided extending in the direction of the inner circumference of the seat ring 2, at the outer edge of the flange 18, is inserted into the through hole 11 in the seat ring 2, so that this does not protrude beyond the outer circumferential face of the seat ring 2, and sealed mounting is brought about using the sealing member 23, in the valve stern fitting hole 16 that is provided in the valve element 4. The test results are shown in Table 1 and Table 2, respectively. Note that, in Table 1 and Table 2, “good” indicates that leakage did not occur, and “poor” indicates that leakage occurred within the valve element.

### Comparative Example 1

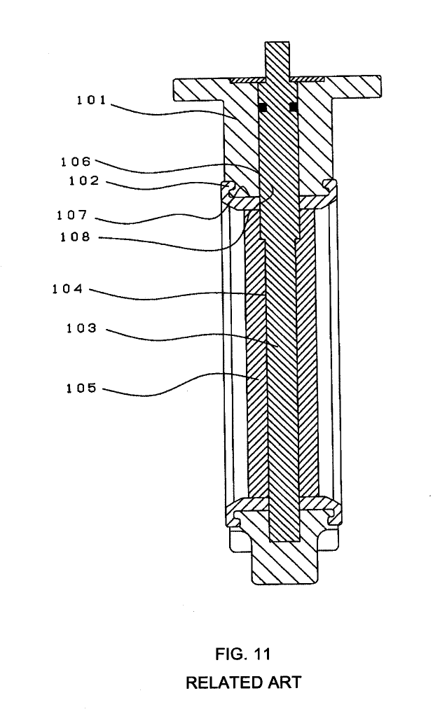

The prior art butterfly valve shown in FIG. 11, which is not provided with the bush 5 as a constituent part, was used as in Working Example 1, and the valve seat sealing test and durability test were performed. The test results are shown together with those for Working Example 1, in Table 1 and Table 2.

TABLE 1
Valve Seat Sealing Test

| | Working Example 1 | Comparative Example 1 |
|---|---|---|
| sealing test | good | poor |
| (1.5 MPa) | | (1.4 MPa leak) |

As will be understood from Table 1, in Working Example 1, there was no fluid leakage at a fluid pressure of 1.5 MPa. In Comparative Example 1, at a fluid pressure of 1.4 MPa, leakage occurred within the valve element, which is to say, leakage into the gap 29 between the valve stem hole 15 and the valve stem 3. Accordingly, the test was not performed for a fluid pressure of 1.5 MPa. From the foregoing, it was confirmed that, with the butterfly valve of the present invention, which is provided with a bush 5, having a seal structure between the bush 5 and the valve element 4, which uses the seal member 23, even if flexure occurs in the valve element 4 as a result of fluid pressure, leakage of fluid into the gap 29 between the valve stem hole 15 in the valve element 4 and the valve stem 3 can be prevented, and reliable sealing can be maintained.

TABLE 2
Durability Test

| | | Working | Comparative |
|---|---|---|---|
| | | Example 1 | Example 1 |
| Durability Test | 10,000 times | good | poor |
| | 20,000 times | good | poor |
| | 30,000 times | good | — |
| | 40,000 times | good | — |
| | 50,000 times | good | — |
| | 60,000 times | good | — |
| | 70,000 times | good | — |
| | 80,000 times | good | — |
| | 90,000 times | good | — |
| | 100,000 times | good | — |

As shown in Table 2, in Working Example 1, there was no fluid leakage, even when repeated open/close operations were performed 100,000 times. Meanwhile, in Comparative Example 1, leakage occurred within the valve element, with 10,000 repeated open/close operations. From these results, it was confirmed that, with a butterfly valve such as in Working Example 1, wherein, in addition to the seal structure that results from the seat ring 2 and the valve element 4, a seal structure is provided with respect to the valve stem fitting hole 16 in the valve element 4, by way of installing the sealing member 23 in the valve fitting part 22 of the bush 5, as compared to a butterfly valve wherein, as in Comparative Example 1, the structure does not have means for preventing penetration of the fluid into the valve stem hole 15, in addition to the seal structure resulting from the seat ring 2 and the valve element 4, even if this is repeated fully opened and closed over long-term use, fluid can be prevented from leaking into the gap 29 between the valve stem hole 15 in the valve element 4 and the valve stem 3, and a reliable seal can be maintained. This is thought to be because, while in Comparative Example 1, the seat ring 2 is abraded by the repeated full opening and closing, so that when flexure occurs in the valve element 4 due to the fluid pressure, a gap 30 tends to occur between the seat ring 2 and the valve element 4, and thus there are likely to be leaks within the valve element, with Working Example 1, even if a gap 30 forms between the seat ring 2 and the valve element 4, because a seal structure is provided between the bush 5 and the valve element 4, it is possible to prevent leakage within the valve element.

Furthermore, in these tests, valve stem leakage did not occur in either Working Example 1 or Comparative Example 1, but it is thought that, in Comparative Example 1, as a result of repeatedly fully opening and closing, valve stem leakage would be likely to occur over long-term use, due to abrasion of the through hole 11 in the seat ring 2. Meanwhile, in Working Example 1, because the bush 5 is installed between the valve stem 3 and the seat ring 2, and the bush 5 is provided so as to be non-turnable with respect to the seat ring 2, the through hole 11 in the seat ring 2 will not be abraded. Furthermore, by abutting and pressing the flange 18 and the annular protruding part 19 of the bush 5 in the fitting recess 20 and the fitting groove 21 in the seat ring 2, a sufficient sealing area can be formed between the seat ring 2 and the bush 5, and deformation of the through hole 11 can be prevented. Accordingly, even if Working Example 1 is repeatedly fully opened and closed over long-term use, it is possible to prevent valve stem leakage from occurring.

1. A butterfly valve comprising: a seat ring that is mounted on an inner circumferential face of a valve body; a valve stem that passes through a through hole in the seat ring, and is supported by the valve body; a discoid valve element that is supported by way of fixing the valve stem in a valve stem fitting hole in the valve element and which is opened and closed as a result of the valve element turning together with the valve stem; and a hollow cylindrical bush inserted in the through hole in the seat ring and mounted in a sealed manner in the valve stem fitting hole in the valve element, without projecting beyond an outer circumferential face of the seat ring.

2. The butterfly valve recited in claim 1, further comprising a flange provided on the bush, on a side of the bush that corresponds to the outer circumferential face of the seat ring.

3. The butterfly valve recited in claim 2, further comprising an annular protrusion at an outer edge of the flange and extending toward the inner circumference of the seat ring.

4. The butterfly valve recited in claim 2, wherein the flange is provided at a top end of the bush, on a side of the bush that corresponds to the outer circumferential face of the seat ring.

5. The butterfly valve recited in claim 1, wherein the top end of the bush comprises a curved face of the bush on a side of the bush that corresponds to the outer circumferential face of the seat ring.

6. The butterfly valve recited in claim 1, wherein the bush is installed so as to be non-turnable with respect to the seat ring.

7. The butterfly valve recited in claim 1, further comprising an annular groove for mounting a sealing member; the annular groove being provided on at least one of: a valve element fitting part that is formed on an outside of the bush; and the valve stem fitting hole.

8. The butterfly valve recited in claim 1, further comprising a stepped portion for mounting the sealing member, the stepped portion being provided on at least one of: the valve element fitting part; and the valve stem fitting hole.

9. The butterfly valve recited in claim 1, further comprising a manual, pneumatic or electric drive system for turning the valve element.
